(19) United States
(12) Patent Application Publication
(10) Pub. No.: US 2023/0295450 A1
(43) Pub. Date: Sep. 21, 2023

(54) WHITE INKJET INK FOR TEXTILE PRINTING, INK SET, AND METHOD FOR PRODUCING PRINTED TEXTILE ITEM

(71) Applicant: RISO KAGAKU CORPORATION, Tokyo (JP)

(72) Inventors: Akiko HAYASHI, Ibaraki (JP); Kokoro KINOE, Ibaraki (JP); Shinichiro SHIMURA, Ibaraki (JP); Tetsuya SHIRAISHI, Ibaraki (JP); Yuki URANO, Ibaraki (JP)

(21) Appl. No.: 18/179,653

(22) Filed: Mar. 7, 2023

(30) Foreign Application Priority Data
Mar. 15, 2022 (JP) 2022-040324

(51) Int. Cl. C09D 11/322; C09D 11/38; C09D 11/033; C09D 11/037; C09D 11/102; C09D 11/40; C09D 11/54; D06P 5/30; D06P 5/00; D06P 1/52; D06P 1/673; B41M 5/00; B41J 2/21; B41J 3/407

(52) U.S. Cl. CPC C09D 11/322; C09D 11/38; C09D 11/033; C09D 11/037; C09D 11/102; C09D 11/40; C09D 11/54; D06P 5/30; D06P 5/002; D06P 1/5285; D06P 1/673; B41M 5/0017; B41J 2/2117; B41J 3/4078

(57) ABSTRACT

Provided is a white inkjet ink for textile printing including: a white inorganic pigment, resin particles A, resin particles B, and water, in which a film elongation of the resin particles A is at least 1000%, the resin particles B are ionic resin particles with an average particle size of not more than 150 nm, and an average particle size of the resin particles A is twice or more than the average particle size of the resin particles B. An ink set and a method for producing a printed textile item are also provided.

### CROSS REFERENCE TO RELATED APPLICATIONS

This application is based upon and claims the benefit of priority from the prior Japanese Patent Application No. 2022-040324, filed on Mar. 15, 2022, the entire contents of which are incorporated by reference herein.

### BACKGROUND OF THE INVENTION

### Field of the Invention

Embodiments of the present invention relate to a white inkjet ink for textile printing, an ink set, and a method for producing a printed textile item.

### DESCRIPTION OF THE RELATED ART

In addition to screen textile printing methods and roller textile printing methods, inkjet textile printing methods are attracting attention as methods for performing textile printing of images such as letters, pictures, designs, and the like on fabrics such as woven fabrics, knitted fabrics, and nonwoven fabrics.

Compared with an image formed on a light colored fabric such as a white fabric, an image formed on a dark colored fabric such as a black fabric is less visible. JP 2009-30014 A discloses a method in which a pretreatment agent containing a polyvalent metal salt is applied to a dark colored fabric such as a black fabric, then an ink containing a white pigment is applied thereon to form a white image, and a desired image is formed thereon. Further, JP 2009-30014 A discloses that a heat treatment is performed after the pretreatment agent is applied.

### SUMMARY OF THE INVENTION

One embodiment of the present invention relates to a white inkjet ink for textile printing including: a white inorganic pigment, resin particles A, resin particles B, and water, in which a film elongation of the resin particles A is at least 1000%, the resin particles B are ionic resin particles with an average particle size of not more than 150 nm, and an average particle size of the resin particles A is twice or more than the average particle size of the resin particles B.

Another embodiment of the present invention relates to an ink set including: the white inkjet ink for textile printing of one embodiment described above, and a pretreatment liquid containing a polyvalent metal salt, water, and a water-soluble organic solvent.

Another embodiment of the present invention relates to a method for producing a printed textile item including: applying a pretreatment liquid containing a polyvalent metal salt, water, and a water-soluble organic solvent to a fabric; and applying the white inkjet ink for textile printing of one embodiment described above, using an inkjet method and a wet-on-wet method, to the fabric to which the pretreatment liquid has been applied.

Another embodiment of the present invention relates to a method for producing a white inkjet ink for textile printing, including: mixing a white inorganic pigment, resin particles A, resin particles B, and water, in which a film elongation of the resin particles A is at least 1000%, the resin particles B are ionic resin particles with an average particle size of not more than 150 nm, and an average particle size of the resin particles A is twice or more than the average particle size of the resin particles B.

Embodiments of the present invention will be described in detail below, but it is needless to say that the present invention is not limited to these embodiments and various modifications and alterations are possible.

### White Inkjet Ink for Textile Printing

A white inkjet ink for textile printing of one embodiment contains a white inorganic pigment, resin particles A, resin particles B, and water, and in the white inkjet ink for textile printing of one embodiment, the film elongation of the resin particles A is at least 1000%, the resin particles B are ionic resin particles with an average particle size of not more than 150 nm, and an average particle size of the resin particles A is twice or more than the average particle size of the resin particles B.

When the white inkjet ink for textile printing is used, it is possible to form a white image with excellent concealment properties. In particular, it is possible to form a white image with excellent concealment properties even when the white inkjet ink for textile printing is applied to a fabric by means of a wet-on-wet method after the application of a pretreatment liquid.

The uniformity and whiteness of the white image can be considered as factors that affect the concealment properties of the white image formed using white ink, but the factors are not limited thereto.

Meanwhile, suppose that a white image is formed by first adhering a pretreatment liquid containing an aggregating agent to a fabric, and then applying the white ink by means of what is referred to as a wet-on-wet method without providing a drying step. In the above case, a white image with favorable concealment properties may not be obtained. The reasons for the above are estimated to be as follows, but the reasons are not limited thereto.

When a liquid is applied to a fluffy substrate such as a fabric, fluff crest portions are more likely to have a pool of liquid occur therein and fluff trough portions are less likely to receive a supply of liquid. Suppose that the pretreatment liquid is applied to the fluffy substrate and then white ink is applied to the fluffy substrate without providing a drying step. In the above case, uneven distribution of the liquid as described above tends to make the white image non-uniform compared with the case of a wet-on-dry method for applying the white ink to a dried substrate. In addition, inorganic pigments such as titanium oxide and zinc oxide are generally useful as white colorants from the viewpoint of ensuring whiteness. However, inorganic pigments tend to have a lower amount of functional groups on the surfaces of the pigments than organic pigments, and therefore inorganic pigments tend to have a lower reactivity with the pretreatment liquid. For this reason, if white ink containing inorganic pigments is applied to a wet substrate by means of the wet-on-wet method, the inorganic pigments tend to blend into the solvent and easily penetrate the substrate and the whiteness tends to easily decrease compared with applying white ink by means of the wet-on-dry method.

Although not constrained by any particular theory, a white inkjet ink for textile printing of one embodiment is estimated to act as follows.

The white inkjet ink for textile printing of one embodiment contains resin particles A of which the film elongation is at least 1000% and resin particles B which are ionic resin particles with an average particle size of not more than 150 nm, and the average particle size of the resin particles A is twice or more than the average particle size of the resin particles B.

The resin particles B are small particles with an average particle size of not more than 150 nm, and therefore, the resin particles B may easily enter gaps between fibers of the substrate. In addition, since the resin particles B are ionic, in those cases where the resin particles B come into contact with a pretreatment liquid containing an aggregating agent such as a polyvalent metal salt, the resin particles can aggregate, and can exert a filling effect of suppressing the penetration of ink components into the substrate. These can enhance the whiteness of the white image.

Meanwhile, the average particle size of the resin particles A is twice or more than the average particle size of the resin particles B. Therefore, the resin particles A tend to remain on the resin particles B on the substrate. Furthermore, since the film elongation of the resin particles A is at least 1000%, the resin particles A may be easily stretched, and, therefore, the layer of the resin particles A on the layer of the resin particles B may be stretched well in the X- and Y-axis directions by means of heating and pressurizing. Accordingly, the ink distribution can be easily homogenized even if a fluffy substrate is used. This makes it easy to enhance the uniformity of the white image.

In this way, it is possible to enhance the whiteness and uniformity of a white image and form a white image with excellent concealment properties. In particular, it is possible to form a white image with excellent concealment properties even if the pretreatment liquid is applied first, and then the white inkjet ink for textile printing is applied to a fabric by means of the wet-on-wet method.

The white inkjet ink for textile printing may contain a white inorganic pigment as a colorant.

Examples of white inorganic pigments include titanium oxide, zinc oxide, zinc sulfide, antimony oxide, zirconium oxide, and the like. Among them, it is preferable to use titanium oxide from the viewpoint of concealment properties. The average particle size of titanium oxide is preferably at least 100 nm from the viewpoint of concealment properties and not more than 600 nm from the viewpoint of jetting stability.

As the white inorganic pigment, a pigment dispersion containing a pigment that has already been dispersed by using a pigment dispersant may be used. Pigment dispersions that have been dispersed with pigment dispersants described below may be used.

A single white inorganic pigment may be used, or a combination of two or more white inorganic pigments may be used.

The amount of the white inorganic pigment relative to the total amount of the white inkjet ink for textile printing is preferably 1 to 30% by mass, more preferably 3 to 20% by mass, and even more preferably 5 to 15% by mass from the viewpoint of concealment properties and the like.

Pigment dispersants typified by polymer dispersants, surfactant-type dispersants, and the like can be used to stably disperse the white inorganic pigment in the white inkjet ink for textile printing.

Examples of commercially available products of the polymer dispersants include the TEGO Dispers series of products manufactured by Evonik Industries AG such as “TEGO Dispers 740W”, “TEGO Dispers 750W”, “TEGO Dispers 755W”, “TEGO Dispers 757W”, and “TEGO Dispers 760W”; the Solsperse series of products manufactured by The Lubrizol Corporation such as “Solsperse 20000”, “Solsperse 27000”, “Solsperse 41000”, “Solsperse 41090”, “Solsperse 43000”, “Solsperse 44000”, and “Solsperse 46000”; the Joncryl series of products manufactured by BASF Japan Ltd. such as “Joncryl 57”, “Joncryl 60”, “Joncryl 62”, “Joncryl 63”, “Joncryl 71”, and “Joncryl 501”; “DISPERBYK-102”, “DISPERBYK-185”, “DISPERBYK-190”, “DISPERBYK-193”, and “DISPERBYK-199” manufactured by BYK-Chemie Japan K.K.; and “Polyvinylpyrrolidone K-30” and “Polyvinylpyrrolidone K-90” manufactured by DKS Co., Ltd. (wherein all of the above are product names).

Examples of the surfactant-type dispersants include anionic surfactants, including the DEMOL series of products manufactured by Kao Corporation such as “DEMOL P”, “DEMOL EP”, “DEMOL N”, “DEMOL RN”, “DEMOL NL”, “DEMOL RNL”, and “DEMOL T-45”; and nonionic surfactants including the EMULGEN series of products manufactured by Kao Corporation such as “EMULGEN A-60”, “EMULGEN A-90”, “EMULGEN A-500”, “EMULGEN B-40”, “EMULGEN L-40”, and “EMULGEN 420” (wherein all of the above are product names).

One of the pigment dispersants described above may be used alone or a combination of two or more may be used.

When used, there are no particular limitations on the blend amount of the pigment dispersant in the white inkjet ink for textile printing, which varies depending on the type of pigment dispersant used, but generally, the amount of the pigment dispersant, expressed as a mass ratio of the active component relative to a value of 1 for the pigment (the pigment concentration), is preferably within a range from 0.005 to 0.5.

The white inkjet ink for textile printing may contain the resin particles A.

It is preferable that the resin particles A can be dispersed in an aqueous solvent. It is preferable that the resin particles A can be dispersed in water without being dissolved in the water and form an oil-in-water (O/W) type emulsion.

The resin particles A are preferably contained in the white inkjet ink for textile printing in a dispersed state as resin particles. The resin particles A can be blended into the ink in the form of a water dispersion of the resin particles, when the white inkjet ink for textile printing is manufactured.

The resin particles A may be a resin in which the functional groups of the resin are located on the resin particle surfaces, as in the case of a self-emulsifying resin, or may be a resin that has been subjected to a surface treatment by, for example, adhering a dispersant to the resin particle surfaces.

The resin particles A may be anionic, cationic, nonionic, or amphoteric, for example, but are preferably anionic or nonionic.

The anionic resin particles may be a resin in which anionic functional groups of the resin are located on the resin particle surfaces, as in the case of a self-emulsifying resin, or may be a resin that has been subjected to a surface treatment by, for example, adhering an anionic dispersant to the resin particle surfaces. Examples of typical anionic functional groups include carboxyl groups, sulfo groups, sulfino groups, sulfuric acid ester groups, phosphoric acid groups, phosphoric acid ester groups, phosphorous acid groups, phosphorous acid ester groups, and the like. Examples of anionic dispersants include anion surfactants and the like.

The nonionic resin particles may be resin particles in which nonionic functional groups of the resin are located on the resin particle surfaces, as in the case of a self-emulsifying resin, or may be resin particles that have been subjected to a surface treatment by, for example, adhering a nonionic dispersant to the resin particle surfaces. Examples of typical nonionic functional groups include polyoxyalkylene glycol groups, carboxyl groups, and hydroxyl groups. Examples of the nonionic dispersant include nonionic surfactants and the like.

The film elongation of the resin particles A may be at least 1000%, preferably at least 1200%, and, from the viewpoint of further enhancing the uniformity of the white image, more preferably 1500% or greater.

The film elongation of resin particles can be measured according to the following procedure. First, a water dispersion of the resin particles is applied to a polytetrafluoroethylene sheet in an amount sufficient to achieve a dried film thickness of 500 μtm. Then, the applied resin dispersion is dried at 23° C. for 15 hours, and then dried at 80° C. for 6 hours, and at 120° C. for 20 minutes. Thereafter, the resultant film is detached from the sheet to complete production of a resin film. The obtained resin film is cut into columns of 2 cm wide and 4 cm long to obtain a resin film test piece. Using a tensile tester, at a measurement temperature of 20° C. and a measurement speed of 200 mm/min, the obtained resin film test piece is stretched, and the length of the stretched resin film test piece when the resin film test piece breaks is measured. The value of the ratio of this stretched length relative to the original length, expressed as a percentage, is deemed the film elongation. The Tensilon Universal Tester RTC-1225A (manufactured by ORIENTEC CO., LTD.) can be used as the tensile tester.

The average particle size of the resin particles A may be twice or more than that of the resin particles B.

The average particle size of the resin particles A is preferably three times or more and more preferably four times or more than the average particle size of the resin particles B. In this case, the resin particles A tend to remain on the aggregated resin particles B. This may make it easier to exhibit a better filling effect by means of the resin particles B and may further enhance whiteness of the white image.

The average particle size of the resin particles A is preferably larger than 150 nm, more preferably at least 200 nm, even more preferably at least 250 nm, and even more preferably at least 300 nm. The larger the average particle size of the resin particles A, the smaller the contact area between the resin particles A and the pretreatment liquid. Accordingly, bonding between the resin particles may be less affected by the pretreatment liquid, and a more uniform ink coating film can be formed. Meanwhile, the average particle size of the resin particles A is preferably not more than 600 nm, and more preferably not more than 500 nm. The average particle size of the resin particles A is preferably larger than 150 nm and not more than 600 nm, more preferably at least 200 nm and not more than 600 nm, even more preferably at least 250 nm and not more than 500 nm, and even more preferably at least 300 nm and not more than 500 nm, for example.

In the present specification, the average particle size of resin particles is the volume-based median diameter in a particle size distribution measured by means of a dynamic light scattering method. The particle size distribution of resin particles can be measured at 25° C. using a measurement sample prepared by diluting a dispersion of the resin particles with water such that the resin particle concentration becomes 0.5% by mass. As a dynamic light scattering type of particle size distribution measuring apparatus, a nanoparticle analyzer “nano Partica SZ-100” (manufactured by HORIBA, Ltd.) can be used.

The average particle size of the resin particles is preferably measured in the state of the raw material resin particle dispersion of the raw material before the ink is prepared, because the influence of the colorant can be eliminated. The measured value can be used as the average particle size of the resin particles.

In terms of the type of the resin particles A used, the use of a resin that forms a transparent coating film is preferred.

Examples of the resin of the resin particles A include: conjugated diene-based resins such as styrene-butadiene copolymers, methyl methacrylate-butadiene copolymers, and vinyl chloride-vinyl acetate copolymers; acrylic-based resins such as polymers of acrylic acid esters and/or methacrylic acid esters, or copolymers thereof with styrene or the like; vinyl-based resins such as ethylene-vinyl acetate copolymers; functional-group modified resins based on monomers containing functional groups such as carboxyl groups of these various resins; melamine resins; urea resins; polyurethane resins; polyester resins; polyolefin resins; silicone resins; polyvinyl butyral resins; and alkyd resins. Resin particles containing one of these resins may be used, but hybrid resin particles may also be used.

The resin particles A are preferably polyurethane resin particles.

Commercially available products of water dispersions of the resin particles A include “Impranil DLP”, “Impranil DLP-R”, “Impranil DLV”, “Impranil DLI”, “Impranil 1016”, “Impranil 1116”, “Impranil DLS”, “Impranil DL 1537”, “Impranil DL 1554”, “Impranil DL 1380”, “Impranil LP CGL 105”, “Impranil DLN-SD”, “Impranil LP DSB 1069”, and “Impranil DLN-W50”, manufactured by Sumika Covestro Urethane Company, Ltd.; and “SUPERFLEX E2000”, “SUPERFLEX 740”, “SUPERFLEX 500M”, “SUPERFLEX 300”, and the like manufactured by DKS Co., Ltd. (wherein all of the above are product names).

A single type of the resin particles A may be used alone, or a combination of two or more types of the resin particles A may be used.

The amount (solid fraction amount) of the resin particles A in the white inkjet ink for textile printing is preferably at least 5% by mass, more preferably at least 8% by mass, and even more preferably at least 10% by mass. The amount (solid fraction amount) of the resin particles A in the white inkjet ink for textile printing is preferably not more than 25% by mass, more preferably not more than 20% by mass, and even more preferably not more than 15% by mass. The amount (solid fraction amount) of the resin particles A in the white inkjet ink for textile printing is preferably 5 to 25% by mass, more preferably 8 to 20% by mass, and even more preferably 10 to 15% by mass, for example.

The amount of the resin particles A in the white inkjet ink for textile printing is preferably larger than that of the resin particles B, which will be described below.

From the viewpoint of further enhancing the uniformity of the white image, the mass ratio of the resin particles A relative to the resin particles B, that is “resin particles A/resin particles B”, is preferably at least 2.5, more preferably at least 3, and even more preferably at least 3.5. If the mass ratio of the resin particles A relative to the resin particles B is at least 2.5, irregularities are more easily mitigated even for a substrate that is very fluffy, and the uniformity of the white image can be further enhanced.

The sum of the amount of the resin particles A and the amount of the resin particles B in the white inkjet ink for textile printing is preferably not less than the amount of the white inorganic pigment. From the viewpoint of further enhancing the uniformity of the white image, the mass ratio of the sum of the resin particles A and the resin particles B relative to the white inorganic pigments, that is “(resin particles A+resin particles B)/white inorganic pigment”, is preferably at least 1, more preferably at least 1.5, and even more preferably at least 2.0. Suppose that the mass ratio of the sum of the resin particles A and the resin particles B relative to white inorganic pigment, that is “(resin particles A +resin particles B)/white inorganic pigment”, is at least 1. In the above case, it tends to be difficult for the white inorganic pigment to enter gaps between the resin particles A and the resin particles A, the bonding between the resin particles A is less affected, and the uniformity can be further enhanced.

The white inkjet ink for textile printing contains the resin particles B.

The resin particles B are preferably resin particles that can be dispersed in an aqueous solvent. It is preferable that the resin particles B are dispersed in water without being dissolved in the water and form an oil-in-water (O/W) type emulsion.

The resin particles B are preferably contained in the white inkjet ink for textile printing in a dispersed state as resin particles. The resin particles B can be blended in the form of a water dispersion of the resin particles when the white inkjet ink for textile printing is manufactured.

The resin particles B are preferably ionic. The resin particles B may be either anionic or cationic, but are more preferably anionic.

Anionic resin particles are particles of negatively charged dispersible resin in which the resin particle surfaces carry a minus charge. The anionic resin particles may be resin particles in which anionic functional groups of the resin are located on the resin particle surfaces, as in the case of self-emulsifying resins, or may be resin particles that have been subjected to a surface treatment by, for example, adhering an anionic dispersant to the resin particle surfaces. Examples of the anionic functional groups include carboxyl groups, sulfo groups, sulfino groups, sulfuric acid ester groups, phosphoric acid groups, phosphoric acid ester groups, phosphorous acid groups, phosphorous acid ester groups, and the like. Examples of anionic dispersants include anion surfactants and the like.

The film elongation of the resin particles B is not particularly limited and may be higher than, similar to, or lower than the film elongation of the resin particles A, for example. The film elongation of the resin particles B is preferably less than 1000% and more preferably not more than 800%.

The average particle size of the resin particles B is preferably not more than 150 nm.

The average particle size of the resin particles B is more preferably not more than 120 nm, even more preferably not more than 100 nm, and even more preferably not more than 80 nm. The smaller the average particle size of the resin particles B, the larger the contact area with the pretreatment liquid. Therefore, the reactivity with the pretreatment liquid may be high.

The average particle size of the resin particles B is preferably at least 10 nm, more preferably at least 30 nm, and even more preferably at least 50 nm. The average particle size of the resin particles B is preferably 10 to 150 nm, more preferably 30 to 120 nm, even more preferably 50 to 100 nm, and even more preferably 50 to 80 nm, for example.

The charge density of the resin particles B is preferably at least 10 μeq/g.

From the viewpoint of further enhancing the whiteness of the white image, the charge density of the resin particles B is more preferably at least 60 μeq/g and even more preferably at least 80 μeq/g. In general, the higher the charge density of the resin particles, the more electrostatic repulsion is relied upon rather than solvation to stabilize the dispersion of the resin particles. If the charge density of the resin particles B is at least 60 μeq/g, salting-out tends to occur more easily when the particles come into contact with the pretreatment liquid, the filling effect is easily exerted on a substrate with many gaps between the fibers, and accordingly a higher whiteness can be easily obtained.

The charge density of the resin particles B is preferably not more than 500 μeq/g, more preferably not more than 300 μeq/g, and even more preferably not more than 200 μeq/g. The charge density of the resin particles B is preferably 10 to 500 μeq/g, more preferably 60 to 300 μeq/g, and even more preferably 80 to 200 μeq/g, for example.

In the present specification, the charge density of resin particles is the charge density measured in accordance with a streaming potential method. The charge density of resin particles is the amount of charge per unit of mass of the solid fraction amount of a water dispersion of resin particles (unit: μeq/g).

Specifically, a water dispersion of the resin particles to be measured is diluted 100 times with water, the obtained dilute liquid is titrated by using 0.0025N poly(diallyldimethylammonium chloride) solution, and the reaction end point where the streaming potential of the dilute liquid reaches 0 V is measured. The total amount of charge of the dilute liquid can be determined from the amount of the 0.0025N poly(diallyldimethylammonium chloride) solution used in reaching this reaction end point. A value obtained by dividing the total amount of charge of the dilute liquid by the solid fraction amount of the resin particles contained in the dilute liquid is the charge density of the resin particles (μeq/g).

A colloid particle charge meter (such as “Model CAS” manufactured by AFG Analytic GmbH) or the like can be used as a charge density measurement device, for example.

In terms of the type of the resin particles B used, the use of a resin that forms a transparent coating film is preferred.

Examples of the resin of the resin particles B include: conjugated diene-based resins such as styrene-butadiene copolymers, methyl methacrylate-butadiene copolymers, and vinyl chloride-vinyl acetate copolymers; acrylic-based resins such as polymers of acrylic acid esters and/or methacrylic acid esters, or copolymers thereof with styrene or the like; vinyl-based resins such as ethylene-vinyl acetate copolymers; functional-group modified resins based on monomers containing functional groups such as carboxyl groups of these various resins; melamine resins; urea resins; polyurethane resins; polyester resins; polyolefin resins; silicone resins; polyvinyl butyral resins; and alkyd resins. Resin particles containing one of these resins may be used but hybrid resin particles may also be used.

The resin particles B are preferably polyurethane resin particles or polyester resin particles.

Examples of commercially available products of water dispersions of the resin particles B include “SUPERFLEX 420”, “SUPERFLEX 150 HS”, “SUPERFLEX 460”, and “SUPERFLEX 470” manufactured by DKS Co., Ltd.; “DAOTAN TW 6450”, “DAOTAN TW 6460” and “DAOTAN VTW 1262” manufactured by Daicel Allnex Ltd.; “Elitel KT 9204” and “Elitel KT 8803” manufactured by UNITIKA LTD.; and “NeoRez R-966” and “NeoRez R-4000” manufactured by DSM (wherein all of the above are product names).

A single type of the resin particles B may be used alone, or a combination of two or more types of the resin particles B may be used.

The amount (solid fraction amount) of the resin particles B in the white inkjet ink for textile printing is preferably at least 1% by mass, more preferably at least 2% by mass, and even more preferably at least 3% by mass. The amount (solid fraction amount) of the resin particles B in the white inkjet ink for textile printing is preferably not more than 15% by mass, more preferably not more than 10% by mass, and even more preferably not more than 5% by mass. The amount (solid fraction amount) of the resin particles B in the white inkjet ink for textile printing is preferably 1 to 15% by mass, more preferably 2 to 10% by mass, and even more preferably 3 to 5% by mass, for example.

The total amount (solid fraction amount) of the resin particles A and the resin particles B relative to the total amount (solid fraction amount) of resin particles in the white inkjet ink for textile printing is preferably at least 50% by mass, more preferably at least 70% by mass, even more preferably at least 90% by mass, even more preferably at least 95% by mass, and may be 100% by mass.

The white inkjet ink for textile printing preferably contains water, and the main solvent may be water.

There are no particular limitations on the water but it is preferably water in which ionic components are as minimal as possible. In particular, from the viewpoint of the ink storage stability, the amount of polyvalent metal ions such as calcium ions is preferably kept low. Examples of the water include ion-exchanged water, distilled water, and ultrapure water.

From the viewpoint of adjustment of the ink viscosity, the amount of water contained relative to the total amount of the white inkjet ink for textile printing is preferably 30 to 70% by mass, more preferably 35 to 65% by mass, and even more preferably 40 to 60% by mass.

The white inkjet ink for textile printing preferably contains a water-soluble organic solvent. Organic compounds that are liquids at room temperature and can be dissolved in water can be used as the water-soluble organic solvent. The use of a water-soluble organic solvent that mixes uniformly with an equal volume of water at 1 atmosphere and 20° C. is preferred. Examples of water-soluble organic solvents that may be used include lower alcohols such as methanol, ethanol, 1-propanol, isopropanol, 1-butanol, 2-butanol, isobutanol, and 2-methyl-2-propanol; glycols such as ethylene glycol, diethylene glycol, triethylene glycol, tetraethylene glycol, polyethylene glycol, propylene glycol, dipropylene glycol, tripropylene glycol, and polypropylene glycol; glycerols such as glycerol, diglycerol, triglycerol, and polyglycerol; acetins such as monoacetin and diacetin; glycol ethers such as ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, triethylene glycol monopropyl ether, triethylene glycol monobutyl ether, tetraethylene glycol monomethyl ether, tetraethylene glycol monoethyl ether, tetraethylene glycol dimethyl ether, and tetraethylene glycol diethyl ether; and triethanolamine, 1-methyl-2-pyrrolidone, 1,3-dimethyl-2-imidazolidinone, β-thiodiglycol, and sulfolane. The boiling point of the water-soluble organic solvent is preferably at least 100° C., and more preferably at least 150° C.

One of these water-soluble organic solvents may be used alone, or a combination of two or more water-soluble organic solvents may be used provided that the solvents form a single phase with water. The amount of the water-soluble organic solvent in the ink is preferably 5 to 50% by mass, and more preferably 10 to 40% by mass.

The white inkjet ink for textile printing preferably contains a surfactant.

Examples of the surfactants that may be used include anionic surfactants, cationic surfactants, amphoteric surfactants, and nonionic surfactants, and one type or a combination of two or more types thereof may be used. Among these, nonionic surfactants are more preferable. The surfactant may be, for example, a low-molecular weight surfactant or a polymer-based surfactant.

The HLB value of the surfactant is preferably 5 to 20, and more preferably 10 to 18.

Examples of the nonionic surfactants include ester-based surfactants such as glycerol fatty acid esters and fatty acid sorbitan esters; ether-based surfactants such as polyoxyethylene alkyl ethers, polyoxyethylene alkylphenyl ethers, and polyoxypropylene alkyl ethers; ether ester-based surfactants such as polyoxyethylene sorbitan fatty acid esters; acetylene-based surfactants; silicone-based surfactants; and fluorine-based surfactants. Among these, acetylene-based surfactants such as acetylene glycol-based surfactants can be used particularly favorably.

Examples of the acetylene-based surfactants include acetylene glycol-based surfactants, acetylene alcohol-based surfactants, and surfactants having an acetylene group.

Acetylene glycol-based surfactants are glycols having an acetylene group, are preferably glycols having a left-right symmetrical structure with an acetylene group in the center, and may include a structure in which ethylene oxide has been added to acetylene glycol.

Examples of commercially available products of acetylene-based surfactants include the SURFYNOL series of products manufactured by Evonik Industries AG such as “SURFYNOL 104E”, “SURFYNOL 104H”, “SURFYNOL 420”, “SURFYNOL 440”, “SURFYNOL 465”, and “SURFYNOL 485”, and the OLFINE series of products manufactured by Nissin Chemical Industry Co., Ltd. such as “OLFINE E1004”, “OLFINE E1010”, and “OLFINE E1020” (wherein all of the above are product names).

Examples of the silicone-based surfactants include polyether-modified silicone-based surfactants, alkyl-aralkyl-comodified silicone-based surfactants, and acrylic silicone-based surfactants.

Examples of commercially available products of silicone-based surfactants include “SILFACE SAG 002” and “SILFACE SAG 503A” manufactured by Nissin Chemical Industry Co., Ltd. (wherein both of the above are product names).

Further examples of other nonionic surfactants include polyoxyethylene alkyl ether-based surfactants such as the EMULGEN series of products manufactured by Kao Corporation including “EMULGEN 102KG”, “EMULGEN 103”, “EMULGEN 104P”, “EMULGEN 105”, “EMULGEN 106”, “EMULGEN 108”, “EMULGEN 120”, “EMULGEN 147”, “EMULGEN 150”, “EMULGEN 220”, “EMULGEN 350”, “EMULGEN 404”, “EMULGEN 420”, “EMULGEN 705”, “EMULGEN 707”, “EMULGEN 709”, “EMULGEN 1108”, “EMULGEN 4085”, and “EMULGEN 2025G” (wherein all of the above are product names).

Examples of the anionic surfactants include the EMAL series of products such as “EMAL 0”, “EMAL 10”, “EMAL 2F”, “EMAL 40”, and “EMAL 20C”, the NEOPELEX series of products such as “NEOPELEX GS”, “NEOPELEX G-15”, “NEOPELEX G-25”, and “NEOPELEX G-65”, the PELEX series of products such as “PELEX OT-P”, “PELEX TR”, “PELEX CS”, “PELEX TA”, “PELEX SS-L”, and “PELEX SS-H”, and the DEMOL series of products such as “DEMOL N, DEMOL NL”, “DEMOL RN”, and “DEMOL MS”, all manufactured by Kao Corporation (wherein all of the above are product names).

Examples of the cationic surfactants include the ACETAMIN series of products such as “ACETAMIN 24” and “ACETAMIN 86”, the QUARTAMIN series of products such as “QUARTAMIN 24P”, “QUARTAMIN 86P”, “QUARTAMIN 60W”, and “QUARTAMIN 86W”, and the SANISOL series of products such as “SANISOL C” and “SANISOL B-50”, all manufactured by Kao Corporation (wherein all of the above are product names).

Examples of the amphoteric surfactants include the AMPHITOL series of products such as “AMPHITOL 20BS”, “AMPHITOL 24B”, “AMPHITOL 86B”, “AMPHITOL 20YB”, and “AMPHITOL 20N” manufactured by Kao Corporation (wherein all of the above are product names).

One of the above surfactants is preferably used alone, but a combination of two or more surfactants may also be used.

The amount of the surfactant relative to the total amount of the white inkjet ink for textile printing is preferably 0.01 to 10% by mass, more preferably 0.1 to 5% by mass, and even more preferably 0.2 to 3% by mass.

The white inkjet ink for textile printing may contain one or more other components if necessary. Examples of these other components include antifoaming agents, pH adjusters and preservatives.

There are no particular limitations on the method used for producing the white inkjet ink for textile printing, and production may be performed using appropriate conventional methods. The white ink may be obtained by using a stirring device such as a three-one motor to disperse all of the components, either in a single batch or in a number of separate batches, and then passing the resulting dispersion through a filtration device such as a membrane filter if desired, for example.

The pH of the white inkjet ink for textile printing is preferably 7.0 to 10.0 and more preferably 7.5 to 9.0, from the viewpoint of the ink storage stability.

The viscosity of the white inkjet ink for textile printing at 23° C. is preferably 1 to 30 mPa·s from the viewpoint of the inkjet jetting characteristics, for example.

The white inkjet ink for textile printing of one embodiment can be preferably used for printing on a fabric.

Examples of the fabric include fabrics including natural fibers such as cotton, silk, wool, and linen; chemical fibers such as polyester, acrylic, polyurethane, nylon, rayon, cupra, and acetate; or combinations of these fibers. Further, the fabric may be a woven fabric, a knitted fabric, a nonwoven fabric, or the like.

### Method for Producing White Inkjet Ink for Textile Printing

A method for producing white inkjet ink for textile printing of one embodiment includes mixing the white inorganic pigment, the resin particles A, the resin particles B, and water. In the method, the film elongation of the resin particles A is at least 1000%, the resin particles B are ionic resin particles with an average particle size of not more than 150 nm, and the average particle size of the resin particles A is twice or more than the average particle size of the resin particles B.

As the white inorganic pigment, the resin particles A, the resin particles B, and water, those described above in the white inkjet ink for textile printing can be used. Other components may be mixed together with the white inorganic pigment, the resin particles A, the resin particles B, and water when necessary. Examples of other components include surfactants, water-soluble organic solvents, pigment dispersants, and the like, which are described as components that the white inkjet ink for textile printing described above may contain. The resin particles A may be used in the form of a water dispersion of the resin particles A. Similarly, the resin particles B may also be used in the form of a water dispersion of the resin particles B. The white inorganic pigment may be used in the form of a pigment dispersion containing a pigment that has already been dispersed by using a pigment dispersant. These components may be mixed either in a single batch or in a number of separate batches. All of the components may be dispersed by putting all of the components into a stirring device such as a three-one motor, either in a single batch or in a number of separate batches, for example. If desired, filtration may be performed by using a filtration device such as a membrane filter.

The above white inkjet ink for textile printing can be produced by means of this method for producing white inkjet ink for textile printing.

### Ink Set

An ink set of one embodiment includes a white inkjet ink for textile printing and a pretreatment liquid containing a polyvalent metal salt, water, and a water-soluble organic solvent.

As the white inkjet ink for textile printing, the white inkjet ink for textile printing described above can be used.

If the white inkjet ink for textile printing is applied to a fabric after a pretreatment liquid is applied to the fabric using this ink set, it is possible to form a white image with excellent concealment properties. In particular, it is also possible to form a white image with excellent concealment properties if the white inkjet ink for textile printing is applied to the fabric by means of a wet-on-wet method after the application of the pretreatment liquid.

The pretreatment liquid may contain a polyvalent metal salt.

Polyvalent metal salts are composed of a divalent or higher polyvalent metal ion and an anion. Examples of the divalent or higher polyvalent metal ion include Ca²⁺, Mg²⁺, Cu²⁺, Ni²⁺, Zn²⁺, and Ba²⁺. Examples of the anion include Cl⁻, NO₃⁻, CH₃COO⁻, I⁻, Br⁻, and ClO₃⁻. Specific examples of the polyvalent metal salts include calcium chloride, calcium nitrate, magnesium nitrate, copper nitrate, calcium acetate, and magnesium acetate.

One of these polyvalent metal salts may be used alone or a combination of two or more may be used.

The amount (the amount of active component) of the polyvalent metal salt relative to the total amount of the pretreatment liquid is preferably at least 5% by mass, more preferably at least 10% by mass, and even more preferably at least 15% by mass. Meanwhile, the amount (the amount of active component) of the polyvalent metal salt relative to the total amount of the pretreatment liquid is preferably not more than 40% by mass, more preferably not more than 35% by mass, and even more preferably not more than 30% by mass. The amount (the amount of active component) of the polyvalent metal salt relative to the total amount of the pretreatment liquid is preferably 5 to 40% by mass, more preferably 10 to 35% by mass, and even more preferably 15 to 30% by mass, for example.

In those cases where a metal salt hydrate is used as the polyvalent metal salt, the amount (the amount of active component) of the polyvalent metal salt refers to the equivalent amount of the anhydrous salt.

The pretreatment liquid preferably contains water. In the pretreatment liquid, the main solvent may be water.

There are no particular limitations on the water, but water containing as few ionic components as possible is preferred. Examples of the water include ion-exchanged water, distilled water, and ultrapure water.

The amount of water relative to the total amount of the pretreatment liquid is preferably 20 to 80% by mass, more preferably 30 to 70% by mass, and even more preferably 40 to 60% by mass.

The pretreatment liquid preferably contains a water-soluble organic solvent. Organic compounds that are liquid at room temperature and can be dissolved in water can be used as the water-soluble organic solvent, and the use of a water-soluble organic solvent that mixes uniformly with an equal volume of water at 1 atmosphere and 20° C. is preferred. The boiling point of the water-soluble organic solvent is preferably at least 100° C. and more preferably at least 150° C. Examples of the water-soluble organic solvent that may be used in the pretreatment liquid include those described above in relation to the white inkjet ink for textile printing.

A single water-soluble organic solvent may be used, or a combination of two or more water-soluble organic solvents may be used provided that the solvents form a single phase with water. The amount of the water-soluble organic solvent relative to the total amount of the pretreatment liquid is preferably 1 to 50% by mass, more preferably 5 to 40% by mass, and even more preferably 10 to 30% by mass.

The pretreatment liquid preferably contains a surfactant. Examples of the surfactants that may be used include anionic surfactants, cationic surfactants, amphoteric surfactants, and nonionic surfactants, and one type or a combination of two or more types thereof may be used. Among these surfactants, nonionic surfactants are particularly preferred. The surfactant may be, for example, a low-molecular weight surfactant or a polymer-based surfactant.

The HLB value of the surfactant is preferably 5 to 20, and more preferably 10 to 18.

Examples of the surfactant that may be used in the pretreatment liquid include those described above in relation to the white inkjet ink for textile printing.

Either a single surfactant or a combination of two or more surfactants may be used.

The amount of the surfactant relative to the total amount of the pretreatment liquid is preferably 0.01 to 10% by mass, more preferably 0.1 to 5% by mass, and even more preferably 0.2 to 3% by mass.

The pretreatment liquid may contain one or more other components if necessary. Examples of these other components include antifoaming agents, pH adjusters, antioxidants, preservatives, and the like.

There are no particular limitations on the method used for producing the pretreatment liquid, and production may be performed using appropriate conventional methods. The pretreatment liquid may be obtained by using a stirring device such as a three-one motor to disperse all of the components, either in a single batch or in a number of separate batches, and then passing the resulting dispersion through a filtration device such as a membrane filter if desired, for example.

The pH of the pretreatment liquid is preferably 3 to 9, and more preferably 4 to 8.

The viscosity of the pretreatment liquid at 23° C. is preferably 1 to 30 mPa·s.

The ink set preferably further contains a non-white inkjet ink for textile printing.

Examples of the non-white inkjet ink for textile printing include inks other than white ink, such as magenta ink, cyan ink, yellow ink, and black ink.

The non-white inkjet ink for textile printing may contain a colorant.

The non-white inkjet ink for textile printing may contain a pigment, a dye, or a combination thereof as the colorant, but preferably contains a pigment.

The non-white inkjet ink for textile printing preferably contains a non-white pigment as the pigment.

Organic pigments such as azo pigments, phthalocyanine pigments, polycyclic pigments, and dye lake pigments, and inorganic pigments such as carbon blacks and metal oxides may be used as the non-white pigment. Examples of the azo pigments include soluble azo lake pigments, insoluble azo pigments and, condensed azo pigments. Examples of the phthalocyanine pigments include metal phthalocyanine pigments and metal-free phthalocyanine pigments. Examples of the polycyclic pigments include quinacridone-based pigments, perylene-based pigments, perinone-based pigments, isoindoline-based pigments, isoindolinone-based pigments, dioxazine-based pigments, thioindigo-based pigments, anthraquinone-based pigments, quinophthalone-based pigments, metal complex pigments, and diketopyrrolopyrrole (DPP). Examples of the carbon blacks include furnace carbon black, lamp black, acetylene black, and channel black. Any one of these pigments may be used alone, or a combination of two or more pigments may be used.

From the viewpoints of the jetting stability and the storage stability, the average particle size of the pigment particles in the ink, expressed as the volume-based average value in a particle size distribution measured by means of a dynamic light scattering method, is preferably not more than 300 nm, more preferably not more than 200 nm, and even more preferably not more than 150 nm.

A self-dispersing pigment may be blended as the pigment. A self-dispersing pigment is a pigment in which a hydrophilic functional group has been introduced at the pigment surface by means of a chemical treatment or a physical treatment. The hydrophilic functional group introduced into the self-dispersing pigment is preferably a group that has ionicity. By charging the pigment surface either anionically or cationically, the pigment particles can be stably dispersed in water by means of electrostatic repulsion. Examples of preferable anionic functional groups include carboxyl groups, sulfo groups, sulfino groups, sulfuric acid ester groups, phosphoric acid groups, phosphoric acid ester groups, phosphorous acid groups, and phosphorous acid ester groups. Examples of preferable cationic functional groups include quaternary ammonium groups and quaternary phosphonium groups.

These hydrophilic functional groups may be bonded directly to the pigment surface or bonded via another atom grouping. Examples of this other atom grouping include, but are not limited to, alkylene groups, phenylene groups, and naphthylene groups. Examples of the pigment surface treatment method include a diazotization treatment, a sulfonation treatment, a hypochlorous acid treatment, a humic acid treatment, and a vacuum plasma treatment.

Preferable examples of the self-dispersing pigment include “CAB-O-JET 200”, “CAB-O-JET 300”, “CAB-O-JET 250C”, “CAB-O-JET 260M”, “CAB-O-JET 270”, and “CAB-O-JET 450C” of the CAB-O-JET series manufactured by Cabot Corporation; and “BONJET BLACK CW-1”, “BONJET BLACK CW-2”, “BONJET BLACK CW-3”, and “BONJET BLACK CW-4” manufactured by Orient Chemical Industries Co., Ltd. (wherein all of the above are product names).

Microencapsulated pigments in which the pigment has been coated with a resin may also be used as the pigment.

Pigment dispersions containing a pigment that has already been dispersed using a pigment dispersant may also be used. Examples of commercially available products of pigment dispersions including a pigment dispersed using a pigment dispersant include the HOSTAJET series of products manufactured by Clariant AG, and the FUJI SP series of products manufactured by Fuji Pigment Co., Ltd. Pigment dispersions that have been dispersed using the pigment dispersants described below may also be used.

Examples of dyes that can be used favorably include water-soluble dyes and dyes that have been made water-soluble by reduction or the like, selected from among basic dyes, acid dyes, direct dyes, soluble vat dyes, acid mordant dyes, mordant dyes, reactive dyes, vat dyes, and sulfide dyes. Further, dispersible dyes such as azo-based dyes, anthraquinone-based dyes, azomethine-based dyes, and nitro-based dyes can also be used favorably. One of these dyes may be used alone, or a combination of a plurality of dyes may be used.

Either a single colorant or a combination of two or more colorants may be used.

From the viewpoints of the print density and the ink viscosity, the amount of the colorant relative to the total amount of non-white inkjet ink for textile printing is preferably 1 to 10% by mass, more preferably 2 to 8% by mass, and even more preferably 2 to 6% by mass.

In those cases where a pigment is used as the colorant in the non-white inkjet ink for textile printing, pigment dispersants typified by polymer dispersants, surfactant-type dispersants, and the like may be used to ensure stable dispersion of the pigment in the non-white inkjet ink for textile printing.

Examples of the pigment dispersants include those described above in relation to the white inkjet ink for textile printing, and the pigment dispersant may be selected from among these pigment dispersants.

When used, there are no particular limitations on the blend amount of the pigment dispersant in the non-white inkjet ink for textile printing, which varies depending on the type of pigment dispersant used, but generally, the amount of the pigment dispersant, expressed as a mass ratio of the active component relative to a value of 1 for the pigment (the pigment concentration), is preferably 0.005 to 0.5.

The non-white inkjet ink for textile printing may contain resin particles.

It is preferable that the resin particles can be dispersed in an aqueous solvent. It is preferable that the resin particles can be dispersed in water without being dissolved in the water and form an oil-in-water (O/W) type emulsion.

The resin particles are preferably contained in the non-white inkjet ink for textile printing in a dispersed state as resin particles. The resin particles can be blended in the form of a water dispersion of the resin particles when the non-white inkjet ink for textile printing is produced.

The resin particles may be any of anionic resin particles, cationic resin particles, nonionic resin particles, and amphoteric resin particles, but anionic resin particles, nonionic resin particles, or combinations thereof are preferred, for example.

From the viewpoint of the inkjet jetting characteristics, the average particle size of the resin particles is preferably not more than 600 nm, more preferably not more than 300 nm, and more preferably not more than 200 nm. The average particle size of the resin particles may be, for example, 10 nm to 600 nm, 50 nm to 300 nm, or 50 nm to 200 nm.

In terms of the type of resin particles, the use of a resin that forms a transparent coating film is preferred.

Examples of the resin of the resin particles include: conjugated diene-based resins such as styrene-butadiene copolymers, methyl methacrylate-butadiene copolymers, and vinyl chloride-vinyl acetate copolymers; acrylic-based resins such as polymers of acrylic acid esters and/or methacrylic acid esters, or copolymers thereof with styrene or the like; vinyl-based resins such as ethylene-vinyl acetate copolymers, or functional-group modified resins based on monomers containing functional groups such as carboxyl groups of these various resins; melamine resins; urea resins; polyurethane resins; polyester resins; polyolefin resins; silicone resins; polyvinyl butyral resins; and alkyd resins. Resin particles containing one of these resins may be used, but hybrid resin particles may also be used.

The resin particles preferably contain polyurethane resin particles.

The non-white inkjet ink for textile printing preferably contains water. In the non-white inkjet ink for textile printing, the main solvent may be water.

There are no particular limitations on the water, but it is preferably water in which ionic components are as minimal as possible. In particular, from the viewpoint of the ink storage stability, the amount of polyvalent metal ions such as calcium ions is preferably kept low. Examples of the water include ion-exchanged water, distilled water, and ultrapure water.

From the viewpoint of adjustment of the ink viscosity, the amount of water contained relative to the total amount of the non-white inkjet ink for textile printing is preferably 30 to 70% by mass, and more preferably 35 to 65% by mass.

The non-white inkjet ink for textile printing may contain a water-soluble organic solvent. Organic compounds that are liquid at room temperature and can be dissolved in water can be used as the water-soluble organic solvent, and the use of a water-soluble organic solvent that mixes uniformly with an equal volume of water at 1 atmosphere and 20° C. is preferred. The boiling point of the water-soluble organic solvent is preferably at least 100° C. and more preferably at least 150° C.

Examples of the water-soluble organic solvents that may be used in the non-white inkjet ink for textile printing include those described above in relation to the white inkjet ink for textile printing, and the water-soluble organic solvent may be selected from among these water-soluble organic solvents.

One of these water-soluble organic solvents may be used alone, or a combination of two or more water-soluble organic solvents may be used provided that the solvents form a single phase with water.

The amount of the water-soluble organic solvent in the non-white inkjet ink for textile printing relative to the total amount of the non-white inkjet ink for textile printing is preferably 10 to 50% by mass, and more preferably 20 to 40% by mass.

The non-white inkjet ink for textile printing preferably contains a surfactant.

Examples of the surfactants that may be used include anionic surfactants, cationic surfactants, amphoteric surfactants, and nonionic surfactants, and one type or a combination of two or more types thereof may be used. Among these surfactants, nonionic surfactants are more preferable. The surfactant may be, for example, a low-molecular weight surfactant or a polymer-based surfactant.

The HLB value of the surfactant is preferably 5 to 20, and more preferably 10 to 18.

Examples of the surfactant that may be used in the non-white inkjet ink for textile printing include those described above in relation to the white inkjet ink for textile printing, and the surfactant may be selected from among these surfactants. Among these, acetylene-based surfactants such as acetylene glycol-based surfactants can be used particularly favorably

A single surfactant may be used, or a combination of two or more surfactants may be used.

The amount of the surfactant relative to the total amount of non-white inkjet ink for textile printing is preferably 0.01 to 10% by mass, more preferably 0.1 to 5% by mass, and even more preferably 0.2 to 3% by mass.

The non-white inkjet ink for textile printing may contain one or more other components if necessary. Examples of these other components include antifoaming agents, pH adjusters, preservatives, and the like.

There are no particular limitations on the method used for producing the non-white inkjet ink for textile printing, and production may be performed using appropriate conventional methods. The ink may be obtained by using a stirring device such as a three-one motor to disperse all of the components, either in a single batch or in a number of separate batches, and then passing the resulting dispersion through a filtration device such as a membrane filter if desired, for example.

From the viewpoint of the ink storage stability, the pH of the non-white inkjet ink for textile printing is preferably 7.0 to 10.0, and more preferably 7.5 to 9.0.

From the viewpoint of the inkjet jetting characteristics, the viscosity of the non-white inkjet ink for textile printing at 23° C. is preferably 1 to 30 mPa·s, for example.

The ink set may contain one or more non-white inkjet inks for textile printing.

The ink set may contain a post-treatment liquid or the like.

The ink set of one embodiment can be preferably used for printing on a fabric. The fabric may be a fabric described a fabric for which the white inkjet ink for textile printing of one embodiment described above can be used.

### Method for Producing Printed Textile Item

A method for producing a printed textile item of one embodiment can include applying a pretreatment liquid to a fabric (hereinafter also referred to as a “pretreatment liquid application step”) and applying a white inkjet ink for textile printing, using an inkjet method and a wet-on-wet method, to the fabric to which the pretreatment liquid has been applied (hereinafter also referred to as a “step of applying a white inkjet ink for textile printing”). As the pretreatment liquid, a pretreatment liquid described above that may be contained in the ink set of one embodiment described above may be used. As the white inkjet ink for textile printing, a white inkjet ink for textile printing of one embodiment described above can be used. As the fabric, a fabric described as a fabric for which it is possible to use the white inkjet ink for textile printing of one embodiment described above can be used.

The pretreatment liquid application step will be described.

The method for applying a pretreatment liquid to a fabric is not particularly limited, and any method such as a spray method using an airbrush or the like, a dipping method, a pad method, a coating method, or the like can be used, for example. In addition, it is possible to use various printing methods such as inkjet printing (an inkjet method) and screen printing.

There are no particular limitations on the inkjet method, and any one of a piezo method, electrostatic method, and thermal method may be used. When an inkjet printing device is used, liquid droplets of the pretreatment liquid or ink are preferably jetted from the inkjet head based on a digital signal, and the jetted ink droplets are adhered to the fabric.

The region of the fabric to which the pretreatment liquid is applied may be a region of the same shape as the image that is to be formed by using the white inkjet ink for textile printing, may be a broader region that incorporates the shape of the image to be formed by using the white inkjet ink for textile printing, or may be the entire surface of the fabric.

The application region for the pretreatment liquid, the application region for the white inkjet ink for textile printing, and the application region for the non-white inkjet ink for textile printing preferably overlap at least partially.

The amount of the pretreatment liquid applied to the fabric is preferably 10 to 100 g/m², more preferably 20 to 75 g/m², and even more preferably 30 to 50 g/m².

The step of applying a white inkjet ink for textile printing will be described.

The white inkjet ink for textile printing is preferably applied to the fabric using an inkjet method. There are no particular limitations on the inkjet method, and any one of a piezo method, electrostatic method, and thermal method may be used. When an inkjet printing device is used, liquid droplets of the pretreatment liquid or ink are preferably jetted from the inkjet head based on a digital signal, with the jetted ink droplets being adhered to the fabric.

It is preferable that the white inkjet ink for textile printing is applied such that the application region for the pretreatment liquid and the application region for the white inkjet ink for textile printing overlap at least partially. It is preferable that the application region for the pretreatment liquid and the application region for the white inkjet ink for textile printing overlap at least partially.

The white inkjet ink for textile printing is preferably applied, using a wet-on-wet method, to the fabric to which the pretreatment liquid has been applied. The white inkjet ink for textile printing is preferably applied in a state where the moisture has not been completely removed from the fabric to which the pretreatment liquid has been applied. It is preferable that the white inkjet ink for textile printing may be applied while the fabric to which the pretreatment liquid has been applied is maintained in a wet state. Following the application of the pretreatment liquid to the fabric, the white inkjet ink for textile printing is preferably applied to the fabric without first performing a drying step such as heated drying, for example. The temperature of the fabric surface following application of the pretreatment liquid and up until the application of the white inkjet ink for textile printing is preferably not more than 40° C., and more preferably not more than 35° C. Following application of the pretreatment liquid, it is preferable that the white inkjet ink for textile printing is applied in a state where the residual amount of the volatile fraction of the pretreatment liquid on the fabric is still at least 90% by mass. The time period from the application of the pretreatment liquid to the fabric until the application of the white inkjet ink for textile printing is preferably 0.1 to 200 seconds.

There are no particular limitations on the amount of the white inkjet ink for textile printing applied to the fabric, but the amount is preferably 50 to 400 g/m², and more preferably 100 to 200 g/m², for example.

The method for producing a printed textile item preferably further includes applying a non-white inkjet ink for textile printing to the fabric to which the white inkjet ink for textile printing has been applied (hereinafter also referred to as a “step of applying a non-white inkjet ink for textile printing”). As the non-white inkjet ink for textile printing, it is possible to use the non-white inkjet ink for textile printing contained in the ink set of one embodiment described above.

The non-white inkjet ink for textile printing is preferably applied to the fabric using an inkjet method. There are no particular limitations on the inkjet method, and any one of a piezo method, electrostatic method, and thermal method may be used. When an inkjet printing device is used, liquid droplets of the pretreatment liquid or ink are preferably jetted from the inkjet head based on a digital signal, with the jetted ink droplets being adhered to the fabric.

It is preferable that the non-white inkjet ink for textile printing is applied such that the application region for the white inkjet ink for textile printing and the application region for the non-white inkjet ink for textile printing overlap at least partially. It is preferable that the application region for the pretreatment liquid, the application region for the white inkjet ink for textile printing, and the application region for the non-white inkjet ink for textile printing overlap at least partially.

The non-white inkjet ink for textile printing is preferably applied, using a wet-on-wet method, to the fabric to which the white inkjet ink for textile printing has been applied. The non-white inkjet ink for textile printing is preferably applied in a state where the moisture has not been completely removed from the fabric to which the white inkjet ink for textile printing has been applied. It is preferable that the non-white inkjet ink for textile printing be applied while the fabric to which the white inkjet ink for textile printing has been applied is maintained in a wet state. Following the application of the white inkjet ink for textile printing to the fabric, the non-white inkjet ink for textile printing is preferably applied to the fabric without first performing a drying step such as heated drying, for example. The temperature of the fabric surface following application of the white inkjet ink for textile printing and up to the application of the non-white inkjet ink for textile printing is preferably not more than 40° C., and more preferably not more than 35° C. Following the application of the white inkjet ink for textile printing, it is preferable that the non-white inkjet ink for textile printing is applied in a state where the residual amount of the volatile fraction of the white inkjet ink for textile printing on the fabric is still at least 90% by mass. The time period from the application of the white inkjet ink for textile printing to the fabric until the application of the non-white inkjet ink for textile printing is preferably 0.1 to 200 seconds.

The amount of the non-white inkjet ink for textile printing applied to the fabric is not particularly limited, but the amount is preferably 5 to 60 g/m², and more preferably 10 to 30 g/m², for example.

A single non-white inkjet ink for textile printing may be applied, or two or more non-white inkjet inks for textile printing may be applied.

In those cases where the pretreatment liquid is applied using an inkjet method, the application of the pretreatment liquid and the application of the white inkjet ink for textile printing may be performed using separate printing devices or using a single printing device.

Suppose that the step of applying a non-white inkjet ink for textile printing is provided and the non-white inkjet ink for textile printing is applied using an inkjet method, for example. In the above case, the application of the white inkjet ink for textile printing and the application of the non-white inkjet ink for textile printing may be performed by using a single printing device or by using separate printing devices. The application of the pretreatment liquid, the application of the white inkjet ink for textile printing, and the application of the non-white inkjet ink for textile printing may be performed by using a single printing device, for example. Further, two printing devices may be used, one of the two devices may be used for the application of the pretreatment liquid, and the other of the two devices may be used for the application of the white inkjet ink for textile printing and the application of the non-white inkjet ink for textile printing, for example.

It is preferable to provide a step of subjecting a fabric to a heat treatment after the step of applying the white inkjet ink for textile printing or the step of applying the non-white inkjet ink for textile printing.

The heat treatment temperature may be selected appropriately in accordance with the material of the fabric and the like. The heat treatment temperature is preferably at least 100° C., and more preferably at least 150° C., for example. From the viewpoint of reducing any damage to the fabric, the heat treatment temperature is preferably not more than 200° C.

There are no particular limitations on the heating device, and for example, a heat press, roll heater, hot air device, infrared lamp heater, or the like may be used.

The heat treatment time may be selected appropriately in accordance with the heating method and the like, and is preferably 1 second to 10 minutes. The heat treatment time may be 5 seconds to 5 minutes, for example.

A post-treatment liquid application step may be provided after the step of applying the white inkjet ink for textile printing or the step of applying the non-white inkjet ink for textile printing. The step of subjecting the fabric to a heat treatment may be provided after the step of applying the white inkjet ink for textile printing or the step of applying the non-white inkjet ink for textile printing, and thereafter a post-treatment liquid may be applied, for example. The post-treatment liquid may be applied using a wet-on-wet method after the step of applying the white inkjet ink for textile printing or the step of applying the non-white inkjet ink for textile printing, for example. Further, the step of subjecting the fabric to a heat treatment may also be provided after the application of the post-treatment liquid.

### EXAMPLES

Embodiments of the present invention will be described below in further detail by using examples. The present invention is not limited to the examples below.

In the following descriptions, except for the film elongation, “%” represents “% by mass” unless specifically stated otherwise. With respect to the materials in the form of a solution, dispersion, or the like, the amounts shown in each table indicate the total amounts of the materials (in the form of a solution, dispersion, or the like), and the proportions of pigment fractions, resin fractions, active components, and the like are also shown.

### 1. Production of Pretreatment Liquid

Table 1 shows the formulation of the pretreatment liquid. The raw materials were mixed at the blending ratio shown in Table 1, and the obtained mixture was filtered by using a cellulose acetate membrane filter having a pore size of 3 μm. Accordingly, pretreatment liquid UC1 was obtained.

Details of the raw materials shown in Table 1 are as follows.

### (Polyvalent Metal Salt)

Calcium nitrate tetrahydrate: manufactured by FUJIFILM Wako Pure Chemical Corporation, active components (as an anhydrous salt) 69% by mass

### (Surfactant)

OLFINE E1010: acetylene glycol-based surfactant, manufactured by Nissin Chemical Industry Co., Ltd.

### (Water-Soluble Organic Solvent)

Diethylene glycol: manufactured by FUJIFILM Wako Pure Chemical Corporation

TABLE 1
Formulation of pretreatment liquid

| | | Pretreatment |
|---|---|---|
| Units: % by mass | | liquid UC1 |
| Polyvalent metal salt | Calcium nitrate tetrahydrate | 29.0 |
| | (active component 69%) | |
| Surfactant | OLFINE E1010 | 0.5 |
| Water-soluble organic | Diethylene glycol | 29.0 |
| solvent | | |
| Water | Ion-exchanged water | 41.5 |

| | |
|---|---|
| Total (% by mass) | 100.0 |

### 2. Production of Inkjet Inks for Textile Printing

### (1) Production of White Pigment Dispersion

First, 250 g of titanium oxide “R62N” (manufactured by Sakai Chemical Industry Co., Ltd.) as a white inorganic pigment and 10 g (active component: 2.5 g) of “DEMOL EP” (manufactured by Kao Corporation) as a pigment dispersant were mixed with 740 g of ion-exchanged water, and a beads mill (DYNO-MILL KDL model A, manufactured by Shinmaru Enterprises Corporation) containing 0.5 mmø zirconia beads at a fill ratio of 80% was used to disperse the mixture under conditions including a retention time of 2 minutes, thus obtaining a white pigment dispersion (pigment fraction: 25% by mass).

### (2) Production of White Inks

Tables 2 to 4 show the formulations of white inks W1 to W15. The raw materials were mixed at the blending ratios shown in the tables, and the obtained mixtures were filtered by using a cellulose acetate membrane filter having a pore size of 3 μm. Accordingly, the white inks W1 to W15 were obtained.

Details of the raw materials of the white inks W1 to W15 shown in Tables 2 to 4 are as follows.

### (Pigment Dispersion)

White pigment dispersion: obtained using the method described above, pigment fraction: 25% by mass

### (Resin Particles A)

Dispersion A1: “Impranil DLP-R”, water dispersion of polyurethane resin particles, manufactured by Sumika Covestro Urethane Co., Ltd., resin fraction: 50% by mass

Dispersion A2: “SUPERFLEX E2000”, water dispersion of polyurethane resin particles, manufactured by DKS Co., Ltd., resin fraction: 50% by mass

Dispersion A3:“SUPERFLEX 740”, water dispersion of polyurethane resin particles, manufactured by DKS Co., Ltd., resin fraction: 40% by mass

Dispersion C1: “SUPERFLEX 470”, water dispersion of polyurethane resin particles, manufactured by DKS Co., Ltd., resin fraction: 38% by mass

### (Resin Particles B)

Dispersion B 1: “SUPERFLEX 420”, water dispersion of polyurethane resin particles, manufactured by DKS Co., Ltd., resin fraction: 32% by mass, ionic

Dispersion B2: “DAOTAN TW6460” water dispersion of polyurethane resin particles, manufactured by Daicel Allnex Ltd., resin fraction: 35% by mass, ionic

Dispersion B3: “SUPERFLEX 150HS”, water dispersion of polyurethane resin particles, manufactured by DKS Co., Ltd., resin fraction: 30% by mass, ionic

Dispersion B4: “Elitel KT9204”, water dispersion of polyester resin particles, manufactured by UNITIKA LTD., resin fraction: 30% by mass, ionic

Dispersion C2: “Aquacer 515”, water dispersion of polyolefin resin particles, manufactured by BYK-Chemie Japan K.K., resin fraction: 35% by mass, nonionic

### (Surfactant)

OLFINE E1010: acetylene glycol-based surfactant, manufactured by Nissin Chemical Industry Co., Ltd.

### (Water-Soluble Organic Solvents)

Glycerol: manufactured by FUJIFILM Wako Pure Chemical Corporation.

Diethylene glycol: manufactured by FUJIFILM Wako Pure Chemical Corporation.

### 3. Measurement of Film Elongations of Resin Particles

Tables 2 to 4 show the film elongations of resin particles of each of the resin particle dispersions used for white inks W1 to W15 except for dispersion C2. The film elongations of the resin particles shown in the tables are the values obtained by means of the following procedure.

First, each of the water dispersions of the resin particles was applied to a polytetrafluoroethylene sheet in an amount sufficient to achieve a dried film thickness of 500 μm. Then, the applied resin dispersion was dried at 23° C. for 15 hours, and then dried at 80° C. for 6 hours, and at 120° C. for 20 minutes. Thereafter, the resulting film was detached from the sheet to complete production of a resin film. The obtained resin film was cut into columns 2 cm wide and 4 cm long, thus obtaining a resin film test piece. Using a Tensilon Universal Tester RTC-1225A (manufactured by ORIENTEC CO., LTD.), at a measurement temperature of 20° C. and a measurement speed of 200 mm/min, the obtained resin film test piece was stretched, and the length of the stretched resin film test piece when the resin film test piece breaks was measured. The value of the ratio of this stretched length relative to the original length expressed as a percentage was deemed the film elongation.

4. Measurement of average particle size of resin particles

Tables 2 to 4 show average particle sizes of each of the resin particles used for the white inks W1 to W15. A dynamic light scattering type of particle size distribution measuring apparatus “nanoparticle analyzer nano Partica SZ-100” (manufactured by HORIBA, Ltd.) was used to measure the average particle size. The average particle sizes of the resin particles shown in the tables are volume-based median diameters which are obtained by diluting each of the water dispersions of the resin particles with purified water such that the particle concentration becomes 0.5% by mass, and the measurement was performed at a temperature of 25° C. under the following conditions: dispersion medium refractive index: 1.333, sample refractive index: 1.600, and calculation conditions: polydisperse and narrow setting.

### 5. Measurement of charge density of resin particles

Tables 2 to 4 show charge densities of each of the water dispersions of the resin particles used for white inks W1 to W15. The charge densities of each of the water dispersions of the resin particles shown in the tables are values obtained by means of a streaming potential method based on the following procedure. A colloid particle charge meter (manufactured by AFG Analytic GmbH, Model CAS) was used to measure the charge densities. The water dispersion of the resin particles to be measured was diluted 100 times with ion-exchanged water, the dilute liquid was titrated by using 0.0025N poly(diallyldimethylammonium chloride) solution (manufactured by FUJIFILM Wako Pure Chemical Corporation), and the reaction end point where the streaming potential of the sample reaches 0 V was measured. The total amount of charge of the sample (diluted water dispersion of resin particles) was obtained from the amount of the 0.0025N poly(diallyldimethylammonium chloride) solution used in reaching this reaction end point. A value obtained by dividing the total amount of charge of the sample (diluted water dispersion of resin particles) by the solid fraction amount of the resin particles contained in the sample is the charge density of the resin particles (μeq/g)

### 6. Production of Printed Textile Items

The printed textile items of Examples 1 to 10 and Comparative Examples 1 to 5 were produced by means of the following procedure using the pretreatment liquid and white ink produced as above.

Tables 2 to 4 show the white inks used for producing the printed textile items of Examples 1 to 10 and Comparative Examples 1 to 5.

A black cotton T-shirt (product name: Printstar) manufactured by Toms Co., Ltd. was used as a substrate. The pretreatment liquid UC1 was applied to a 10 cm×20 cm portion of the surface of the black cotton T-shirt by means of an inkjet method. The application amount of the pretreatment liquid was about 50 g/m². After the pretreatment liquid was applied, the white ink was applied, by means of an inkjet method without providing a drying step, to the portion to which the pretreatment liquid has been applied. The application amount of the white ink was about 180 g/m². An “MMP-8130” manufactured by Mastermind Inc., was used as a printing device for both the application of the pretreatment liquid and the application of the white ink. Thereafter, heat drying was performed at 160° C. for 2 minutes using a heat press machine manufactured by Fusion Co. Accordingly, printed textile items were obtained.

### 7. Evaluation of printed textile items

The concealment properties due to white images of the printed textile items of Examples 1 to 10 and Comparative Examples 1 to 5 were determined based on the following criteria. Tables 2 to 4 show the evaluation results.
A: The white image has high whiteness and also has good uniformity
B: Although the white image has slightly lower whiteness, the white image has good uniformity
C: The white image has high or slightly low whiteness and slight irregularities are observed in the white image
D: The white image has low whiteness and/or many irregularities are observed in the white image

TABLE 2

| (Units: % by mass) | | | | | | | | | | | |
|---|---|---|---|---|---|---|---|---|---|---|---|
| | | | Charge | | | | Examples | | | | |
| | | | density | Average | | | 1 | 2 | 3 | 4 | 5 |
| | | Film | of resin | particle | | | White | White | White | White | White |
| | | elongation | particles | size | Resin | Pigment | ink | ink | ink | ink | ink |
| Raw material | | (%) | (μeq/g) | (nm) | (%) | (%) | W1 | W2 | W3 | W4 | W5 |
| White pigment | | | | | | 25 | 40.0 | 35.0 | 30.0 | 50.0 | 40.0 |
| dispersion | | | | | | | | | | | |
| Resin | Dispersion | 1600 | 46 | 426 | 50 | | 25.0 | 30.0 | 35.0 | 20.0 | 20.0 |
| particles | A1 | | | | | | | | | | |
| A | Dispersion | 1350 | 1 | 588 | 50 | | | | | | |
| | A2 | | | | | | | | | | |
| | Dispersion | 1300 | 69 | 170 | 40 | | | | | | |
| | A3 | | | | | | | | | | |
| | Dispersion | 640 | 36 | 108 | 38 | | | | | | |
| | C1 | | | | | | | | | | |
| Resin | Dispersion | 290 | 101 | 73 | 32 | | 9.4 | 11.3 | 13.1 | 5.0 | 17.2 |
| particles | B1 | | | | | | | | | | |
| B | Dispersion | 680 | 57 | 70 | 35 | | | | | | |
| | B2 | | | | | | | | | | |
| | Dispersion | 480 | 85 | 83 | 30 | | | | | | |
| | B3 | | | | | | | | | | |
| | Dispersion | <100 | 20 | 108 | 30 | | | | | | |
| | B4 | | | | | | | | | | |
| | Dispersion | | 81 | 74 | 35 | | | | | | |
| | C2 | | | | | | | | | | |

| | | | | | |
|---|---|---|---|---|---|
| OLFINE E1010 | 0.5 | 0.5 | 0.5 | 0.5 | 0.5 |
| Glycerol | 5.0 | 5.0 | 5.0 | 5.0 | 5.0 |
| Diethylene glycol | 15.0 | 15.0 | 15.0 | 15.0 | 15.0 |
| Ion-exchanged water | 5.1 | 3.3 | 1.4 | 4.5 | 2.3 |
| Total (% by mass) | 100.0 | 100.0 | 100.0 | 100.0 | 100.0 |
| Amount of white inorganic pigment (% by mass) | 10.0 | 8.8 | 7.5 | 12.5 | 10.0 |
| Amount of resin particles A (% by mass) | 12.5 | 15.0 | 17.5 | 10.0 | 10.0 |
| Amount of resin particles B (% by mass) | 3.0 | 3.6 | 4.2 | 1.6 | 5.5 |
| Average particle size of resin particles A/ | 5.8 | 5.8 | 5.8 | 5.8 | 5.8 |
| average particle size of resin particles B | | | | | |
| Mass ratio “(resin particles A + resin particles B)/ | 1.6 | 2.1 | 2.9 | 0.9 | 1.6 |
| white inorganic pigment” | | | | | |
| Mass ratio “resin particles A/resin particles B” | 4.2 | 4.2 | 4.2 | 6.3 | 1.8 |
| Concealment properties | A | A | A | C | C |

TABLE 3

| (Units: % by mass) | | | | | | | | | | | |
|---|---|---|---|---|---|---|---|---|---|---|---|
| | | | Charge | | | | Examples | | | | |
| | | | density | Average | | | 6 | 7 | 8 | 9 | 10 |
| | | Film | of resin | particle | | | White | White | White | White | White |
| | | elongation | particles | size | Resin | Pigment | ink | ink | ink | ink | ink |
| Raw material | | (%) | (μeq/g) | (nm) | (%) | (%) | W6 | W7 | W8 | W9 | W10 |
| White pigment | | | | | | 25 | 40.0 | 40.0 | 40.0 | 32.0 | 40.0 |
| dispersion | | | | | | | | | | | |
| Resin | Dispersion | 1600 | 46 | 426 | 50 | | 25.0 | 25.0 | 25.0 | | |
| particles | A1 | | | | | | | | | | |
| A | Dispersion | 1350 | 1 | 588 | 50 | | | | | | 25.0 |
| | A2 | | | | | | | | | | |
| | Dispersion | 1300 | 69 | 170 | 40 | | | | | 31.3 | |
| | A3 | | | | | | | | | | |
| | Dispersion | 640 | 36 | 108 | 38 | | | | | | |
| | C1 | | | | | | | | | | |
| Resin | Dispersion | 290 | 101 | 73 | 32 | | | | | 9.4 | 9.4 |
| particles | B1 | | | | | | | | | | |
| B | Dispersion | 680 | 57 | 70 | 35 | | 8.6 | | | | |
| | B2 | | | | | | | | | | |
| | Dispersion | 480 | 85 | 83 | 30 | | | 10.0 | | | |
| | B3 | | | | | | | | | | |
| | Dispersion | <100 | 20 | 108 | 30 | | | | 10.0 | | |
| | B4 | | | | | | | | | | |
| | Dispersion | | 81 | 74 | 35 | | | | | | |
| | C2 | | | | | | | | | | |

| | | | | | |
|---|---|---|---|---|---|
| OLFINE E1010 | 0.5 | 0.5 | 0.5 | 0.5 | 0.5 |
| Glycerol | 5.0 | 5.0 | 5.0 | 5.0 | 5.0 |
| Diethylene glycol | 15.0 | 15.0 | 15.0 | 15.0 | 15.0 |
| Ion-exchanged water | 5.9 | 4.5 | 4.5 | 6.9 | 5.1 |
| Total (% by mass) | 100.0 | 100.0 | 100.0 | 100.0 | 100.0 |
| Amount of white inorganic pigment (% by mass) | 10.0 | 10.0 | 10.0 | 8.0 | 10.0 |
| Amount of resin particles A (% by mass) | 12.5 | 12.5 | 12.5 | 12.5 | 12.5 |
| Amount of resin particles B (% by mass) | 3.0 | 3.0 | 3.0 | 3.0 | 3.0 |
| Average particle size of resin particles A/ | 6.1 | 5.1 | 3.9 | 2.3 | 8.1 |
| average particle size of resin particles B | | | | | |
| Mass ratio “(resin particles A + resin particles B)/ | 1.6 | 1.6 | 1.6 | 1.9 | 1.6 |
| white inorganic pigment” | | | | | |
| Mass ratio “resin particles A/resin particles B” | 3.8 | 4.2 | 4.2 | 4.2 | 4.2 |
| Concealment properties | B | A | B | C | C |

| (Units: % by mass) | | | | | | | | | | | |
|---|---|---|---|---|---|---|---|---|---|---|---|
| | | | Charge | | | | Comparative examples | | | | |
| | | | density | Average | | | 1 | 2 | 3 | 4 | 5 |
| | | Film | of resin | particle | | | White | White | White | White | White |
| | | elongation | particles | size | Resin | Pigment | ink | ink | ink | ink | ink |
| Raw material | | (%) | (μeq/g) | (nm) | (%) | (%) | W11 | W12 | W13 | W14 | W15 |
| White pigment | | | | | | 25 | 40.0 | 40.0 | 40.0 | 40.0 | 32.0 |
| dispersion | | | | | | | | | | | |
| Resin | Dispersion | 1600 | 46 | 426 | 50 | | 25.0 | 31.0 | | | |
| particles | A1 | | | | | | | | | | |
| A | Dispersion | 1350 | 1 | 588 | 50 | | | | | | |
| | A2 | | | | | | | | | | |
| | Dispersion | 1300 | 69 | 170 | 40 | | | | | | 31.3 |
| | A3 | | | | | | | | | | |
| | Dispersion | 640 | 36 | 108 | 38 | | | | 32.9 | | |
| | C1 | | | | | | | | | | |
| Resin | Dispersion | 290 | 101 | 73 | 32 | | | | 9.4 | 48.4 | |
| particles | B1 | | | | | | | | | | |
| B | Dispersion | 680 | 57 | 70 | 35 | | | | | | |
| | B2 | | | | | | | | | | |
| | Dispersion | 480 | 85 | 83 | 30 | | | | | | |
| | B3 | | | | | | | | | | |
| | Dispersion | <100 | 20 | 108 | 30 | | | | | | 10.0 |
| | B4 | | | | | | | | | | |
| | Dispersion | | 81 | 74 | 35 | | 8.6 | | | | |
| | C2 | | | | | | | | | | |

| | | | | | |
|---|---|---|---|---|---|
| OLFINE E1010 | 0.5 | 0.5 | 0.5 | 0.5 | 0.5 |
| Glycerol | 5.0 | 5.0 | 5.0 | 5.0 | 5.0 |
| Diethylene glycol | 15.0 | 15.0 | 12.2 | 6.1 | 15.0 |
| Ion-exchanged water | 5.9 | 8.5 | 0 | 0 | 6.2 |
| Total (% by mass) | 100.0 | 100.0 | 100.0 | 100.0 | 100.0 |
| Amount of white inorganic pigment (% by mass) | 10.0 | 10.0 | 10.0 | 10.0 | 8.0 |
| Amount of resin particles A (% by mass) | 12.5 | 15.5 | 0.0 | 0.0 | 12.5 |
| Amount of resin particles B (% by mass) | 0.0 | 0.0 | 3.0 | 15.5 | 3.0 |
| Average particle size of resin particles A/ | — | — | — | — | 1.6 |
| average particle size of resin particles B | | | | | |
| Mass ratio “(resin particles A + resin particles B)/ | 1.3 | 1.6 | 0.3 | 1.55 | 1.9 |
| white inorganic pigment” | | | | | |
| Mass ratio “resin particles A/resin particles B” | — | — | — | — | 4.2 |
| Concealment properties | D | D | D | D | D |

The white images of the printed textile items in Examples 1 to 10 had excellent whiteness and uniformity and exhibited excellent concealment properties.

Meanwhile, none of the white images of the printed textile items in Comparative Examples 1 to 5 exhibited sufficient concealment properties. In the printed textile items of Comparative Examples 1 and 2 in which the white ink without the resin particles B is used, the whiteness of the white images was low. In the printed textile items of Comparative Examples 3 and 4 in which the white ink without the resin particles A is used, the uniformity of the white images was poor. In the printed textile item of Comparative Example 5 using the white ink in which the average particle size of the resin particles A was less than twice the average particle size of the resin particles B, the whiteness of the white image was low, and sufficient concealment properties could not be obtained.

### 8. Production of Non-White Ink

Table 5 shows the formulations of non-white inks K1, C1, M1, and Y1. The raw materials were mixed at the blending ratios shown in Table 5, and the obtained mixtures were filtered by using a cellulose acetate membrane filter having a pore size of 3 μm. Accordingly, the non-white inks K1, C1, M1, and Y1 were obtained.

Details of the raw materials of the non-white inks K1, C1, M1, and Y1 shown in Table 5 are as follows.

### (Pigment Dispersion)

CAB-O-JET 300: self-dispersing pigment dispersion (black), manufactured by Cabot Japan K.K., pigment fraction: 15% by mass

CAB-O-JET 250C: self-dispersing pigment dispersion (cyan), manufactured by Cabot Japan K.K., pigment fraction: 10% by mass

CAB-O-JET 260M: self-dispersing pigment dispersion (magenta), manufactured by Cabot Japan K.K., pigment fraction: 10% by mass

CAB-O-JET 270: self-dispersing pigment dispersion (yellow), manufactured by Cabot Japan K.K., pigment fraction: 10% by mass

### (Resin Particles)

SUPERFLEX 470: water dispersions of polyurethane resin particles, manufactured by DKS Co., Ltd., resin fraction: 38% by mass

### (Surfactant)

OLFINE E1010: acetylene glycol-based surfactant, manufactured by Nissin Chemical Industry Co., Ltd.

### (Water-Soluble Organic Solvent)

Diethylene glycol: manufactured by FUJIFILM Wako Pure Chemical Corporation.

TABLE 5

| | | | Non-white inks | | | |
|---|---|---|---|---|---|---|
| (Units: % by mass) | | | K1 | C1 | M1 | Y1 |
| Pigment | CAB-O-JET 300 | Pigment | 33.3 | | | |
| | | 15% | | | | |
| dispersion | CAB-O-JET 250C | Pigment | | 50.0 | | |
| | | 10% | | | | |
| | CAB-O-JET 260M | Pigment | | | 50.0 | |
| | | 10% | | | | |
| | CAB-O-JET 270 | Pigment | | | | 50.0 |
| | | 10% | | | | |
| Resin | SUPERFLEX 470 | Resin | 26.3 | 26.3 | 26.3 | 26.3 |
| particles | | 38% | | | | |
| Surfactant | OLFINE E1010 | | 1.0 | 1.0 | 1.0 | 1.0 |
| Water- | Diethylene glycol | | 20.0 | 20.0 | 20.0 | 20.0 |
| soluble | | | | | | |
| organic | | | | | | |
| solvent | | | | | | |
| Water | Ion-exchanged water | | 19.4 | 2.7 | 2.7 | 2.7 |

| | | | | |
|---|---|---|---|---|
| Total (% by mass) | 100.0 | 100.0 | 100.0 | 100.0 |

### 9. Production of Color Printed Textile Item

The printed textile item was produced by means of the following procedure using the pretreatment liquid UC1, the white ink W2, and the non-white inks K1, C1, M1, and Y1 which were produced as above. A black cotton T-shirt (product name: Printstar) manufactured by Toms Co., Ltd. was used as a substrate, and the pretreatment liquid UC1 was applied to a 10 cm×20 cm portion of the surface of the black cotton T-shirt by means of an inkjet method. The application amount of the pretreatment liquid was about 100 g/m². After the pretreatment liquid was applied, the white ink W2 was applied, by means of an inkjet method without providing a drying step, to the portion to which the pretreatment liquid has been applied. The application amount of the white ink was about 180 g/m². After the white ink was applied, 2 cm ×2 cm monochromatic solid images of the non-white inks K1, C1, M1, and Y1 were printed on the white image individually without providing a drying step. The application amount of each of the non-white inks was 20 g/m2. For the application of all of the pretreatment liquid, white ink, and non-white inks, an “MMP-8130” manufactured by Mastermind Co., Ltd. was used as a printing device. Then, heat drying was performed at 160° C. for 2 minutes by using a heat press machine manufactured by Fusion Co. Accordingly, a color printed textile item was obtained.

### 10. Evaluation of Color Printed Textile Item

The color printed textile item in which the monochromatic solid images of the non-white inks K1, C1, M1, and Y1 were formed on the white image obtained as described above was evaluated visually. The color printed textile item was favorable both in terms of color development properties and bleeding.

It is to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. A white inkjet ink for textile printing comprising:
a white inorganic pigment;
resin particles A;
resin particles B; and
water, wherein
a film elongation of the resin particles A is at least 1000%,
the resin particles B are ionic resin particles with an average particle size of not more than 150 nm, and
an average particle size of the resin particles A is twice or more than the average particle size of the resin particles B.

2. The white inkjet ink for textile printing according to claim 1, wherein
the film elongation of the resin particles A is at least 1500%.

3. The white inkjet ink for textile printing according to claim 1, wherein
a charge density of the resin particles B is at least 60 μeq/g.

4. The white inkjet ink for textile printing according to claim 1, wherein
the average particle size of the resin particles A is four times or more than the average particle size of the resin particles B.

5. The white inkjet ink for textile printing according to claim 1, wherein
a mass ratio of a total amount of the resin particles A and the resin particles B relative to the white inorganic pigment, “(the resin particles A+the resin particles B)/the white inorganic pigment”, is at least 1.

6. The white inkjet ink for textile printing according to claim 1, wherein
a mass ratio of the resin particles A relative to the resin particles B “the resin particles A/the resin particle B” is at least 2.5.

7. An ink set comprising:
the white inkjet ink for textile printing according to claim 1; and
a pretreatment liquid containing a polyvalent metal salt, water, and a water-soluble organic solvent.

8. The ink set according to claim 7, further comprising:
a non-white inkjet ink for textile printing.

9. The ink set according to claim 7, wherein
the film elongation of the resin particles A is at least 1500%.

10. The ink set according to claim 7, wherein
a charge density of the resin particles B is at least 60 μeq/g.

11. The ink set according to claim 7, wherein
the average particle size of the resin particles A is four times or more than the average particle size of the resin particles B.

12. The ink set according to claim 7, wherein
a mass ratio of a total amount of the resin particles A and the resin particles B relative to the white inorganic pigment “(the resin particles A+the resin particles B)/the white inorganic pigment” is at least 1.

13. The ink set according to claim 7, wherein
a mass ratio of the resin particles A relative to the resin particles B “the resin particles A/the resin particle B” is at least 2.5.

14. A method for producing a printed textile item comprising:
applying a pretreatment liquid containing a polyvalent metal salt, water, and a water-soluble organic solvent to a fabric; and
applying the white inkjet ink for textile printing according to claim 1, using an inkjet method and a wet-on-wet method, to the fabric to which the pretreatment liquid has been applied.

15. The method for producing a printed textile item according to claim 14, further comprising:
applying a non-white inkjet ink for textile printing to the fabric to which the white inkjet ink for textile printing has been applied.

16. The method for producing a printed textile item according to claim 14, wherein the film elongation of the resin particles A is at least 1500%.

17. The ink method for producing a printed textile item according to claim 14, wherein
a charge density of the resin particles B is at least 60 μeq/g.

18. The method for producing a printed textile item according to claim 14, wherein
the average particle size of the resin particles A is four times or more than the average particle size of the resin particles B.

19. The method for producing a printed textile item according to claim 14, wherein
a mass ratio of a total amount of the resin particles A and the resin particles B relative to the white inorganic pigment, “(the resin particles A+the resin particles B)/the white inorganic pigment”, is at least 1.

20. The method for producing a printed textile item according to claim 14, wherein
a mass ratio of the resin particles A relative to the resin particles B “the resin particles A/the resin particle B” is at least 2.5.
